(19) United States
(12) Patent Application Publication
(10) Pub. No.: US 2025/0065426 A1
(43) Pub. Date: Feb. 27, 2025

(54) GRINDING MACHINE FOR GEAR GRINDING

(71) Applicant: Klingelnberg AG, Zürich (CH)

(72) Inventor: Kai Döpke, Karlsruhe (DE)

(21) Appl. No.: 18/811,070

(22) Filed: Aug. 21, 2024

(30) Foreign Application Priority Data
Aug. 23, 2023 (DE) 10 2023 122 654.1

(51) Int. Cl. B23F 5/02; B23F 23/12

(52) U.S. Cl. CPC B23F 5/02; B23F 23/12

(57) ABSTRACT

A grinding machine for gear grinding, having a tool spindle for holding a gear machining tool, having a workpiece spindle for holding a workpiece to be toothed, having controlled machine axes for executing relative movements for chip-removing machining of the workpiece to be toothed by the gear machining tool, having a device for applying a cooling fluid, which is set up to introduce cooling fluid into a region of the chip removal between the gear machining tool and the workpiece to be toothed during the chip-removing machining operation, wherein at least one insulation device is provided in order to protect a load-bearing structure and/or a component of the grinding machine from a fluid flow and/or sparking.

### CROSS-REFERENCE TO RELATED APPLICATIONS

This application claims the benefit of German patent application 10 2023 122 654.1, filed on 23 Aug. 2023, the disclosure of which is incorporated herein by reference in its entirety.

### TECHNICAL FIELD

The present disclosure relates to a grinding machine for gear grinding, having a tool spindle for holding a gear machining tool, having a workpiece spindle for holding a workpiece to be toothed, having a plurality of controlled machine axes for executing relative movements for chip-removing machining of the workpiece to be toothed by means of the gear machining tool, having a device for applying a cooling fluid, which is set up to introduce cooling fluid into a region of the chip removal between the gear machining tool and the workpiece to be toothed during the chip-removing machining operation.

### BACKGROUND

The production of gearing usually comprises the process steps of soft machining, hardening and hard finishing. Hard finishing is often carried out by grinding, such as generating grinding or profile grinding.

Tighter and tighter tolerances are required when grinding gears. This trend can be observed, for example, in the continuous generating grinding of spur gears for electromobility. Tolerances are often required here that specify production with deviations in the low single-digit micrometer range. Such tight tolerances pose a particular challenge for machine manufacturers in industrial series production. Even minor changes in environmental influences, such as temperature fluctuations, vibrations and the like, can lead to the specified tight tolerances for individual components not being met during series production.

### SUMMARY

Against this background, the present disclosure is based on the technical problem of providing a grinding machine for gear grinding which enables reliable production to close tolerances, particularly in industrial series production.

According to the disclosure, the technical problem described above is solved by a grinding machine for gear grinding according to the independent claim. Further designs of the disclosure result from the dependent claims and the following description.

According to the disclosure, a grinding machine for gear grinding is provided, having a tool spindle for accommodating a gear machining tool, having a workpiece spindle for accommodating a workpiece to be toothed, having a plurality of controlled machine axes for executing relative movements for chip-removing machining of the workpiece to be toothed by means of the gear machining tool, having a device for applying a cooling fluid, which is set up to introduce cooling fluid into a region of the chip removal between the gear machining tool and the workpiece to be toothed during the chip-removing machining operation. The grinding machine is characterized in that at least one insulation device is provided in order to protect a load-bearing structure and/or a component of the grinding machine from a fluid flow and/or sparking.

Tests carried out by the applicant have shown that even slight heat input or heat dissipation in individual areas of the grinding machine can lead to a loss of machine accuracy in the low single-digit micrometer range.

During gear grinding, a cooling fluid is usually introduced into the grinding contact in order to cool the workpiece and the tool, reduce friction, remove chips and free the tool and the workpiece from chips. The cooling fluid absorbs heat from the grinding contact of the components involved—namely the workpiece and the tool—and is therefore heated in turn.

Contact of the cooling fluid heated in this way, for example with a machine bed of the machine, can lead to heat being transferred via the machine bed wetted with cooling fluid to other components of the grinding machine connected to the machine bed, causing them to expand due to the temperature.

This means that the heat input of the cooling fluid into the machine bed can cause machine axes or machine axis holders to undergo temperature-related expansion, which can lead to an impairment of the machine accuracy in the low micrometer range. Similarly, a failure to wet the machine bed with cooling fluid can lead to a change in the stable temperature state of the machine tool and, for example, to a cooling of the machine bed and associated components during a machining break, i.e. to a temperature fluctuation due to a failure to heat the machine bed with cooling fluid.

Furthermore, the temperature of the cooling fluid flowing towards the machine bed also changes during regular machine operation due to the fact that the cooling fluid is applied continuously during the workpiece change and the cooling fluid is not heated by the metal-machining grinding contact during the workpiece change. The continuous application of the cooling fluid, even during breaks in machining, serves to achieve a uniform cooling volume flow during grinding, which may not be guaranteed if the cooling volume flow is constantly switched on and off.

For this example, it therefore applies that the heat input from the cooling fluid as well as the absence of such a heat input and also the temperature change during regular grinding operation can lead to fluctuations in the machine accuracy, as the actual heat input from the cooling fluid and the associated effects on the machine tool cannot be planned at all times and cannot be taken into account or compensated for by the machine control system.

The insulation device proposed according to the disclosure now ensures that a load-bearing structure and/or a component of the grinding machine is protected from the influence of such a fluid flow and, in this way, the temperature of the load-bearing structure and/or component in question is kept as constant as possible. In particular, the insulation device according to the disclosure ensures that the relevant load-bearing structure and/or component of the grinding machine is thermally decoupled from a fluid flow. This applies equally to protection against sparking.

The example described above clearly illustrates the conditions and influences of the cooling fluid during the grinding process. In the same way, however, environmental influences, such as draughts, or ventilation devices, such as air conditioning systems, can also lead to heat input into a load-bearing structure or to heat dissipation from a load-bearing structure, such as the machine bed mentioned above, and/or a component of the grinding machine.

The term “fluid flow” in the present case includes both the example of a liquid flow in the form of the cooling fluid, as explained in detail above, and gaseous flows, such as ambient air or the like. According to the present text, the term “fluid” therefore includes, as usual, both liquids and gaseous substances or gas mixtures, such as ambient air, compressed air or the like.

The tool spindle can be set up to drive the gear machining tool in rotation. The workpiece spindle can be set up to rotate the workpiece to be toothed.

The device for applying the cooling fluid can be set up to introduce cooling fluid into the chip removal area between the gear machining tool and the workpiece to be toothed during, before and after machining.

The device for applying the cooling fluid can have a pump to pressurize the cooling fluid and introduce it under pressure into the chip removal area between the gear machining tool and the workpiece to be toothed.

When the term “load-bearing structure of the grinding machine” is used in the present case, this may refer to the machine bed of the grinding machine or to load-bearing elements of the grinding machine, such as steel beams, struts or similar structural components. When reference is made here to a component of the grinding machine, this refers in particular to moving axes, parts of moving axes, drives, holders, clamping devices, spindle components or the like.

It may be provided that the insulation device has a flat component, such as a sheet or the like.

The sheet can have a metallic material or consist of a metallic material.

It may be provided that the sheet is bonded or coated with a material that has low thermal conductivity or is bonded by other processes, such as vulcanization or the like.

When a material with a low thermal conductivity is referred to in the present case, such a thermal conductivity, measured in W/(m·K), is in particular less than 2 W/(m·K), further in particular less than 1 W/(m·K), this thermal conductivity being defined, as usual, for 0° C.

According to one design of the grinding machine, it is provided that the flat component is at a distance from the load-bearing structure and/or component of the grinding machine to be protected. In this way, it may be avoided that a heat transfer takes place due to a particularly flat contact between the flat component and the load-bearing structure and/or component to be protected. Insofar as the flat component is intended, for example, to keep a cooling fluid away from the load-bearing structure and/or component of the grinding machine to be protected, only the flat component is heated by contact with the cooling fluid, but this heat is not transferred via the flat component to the load-bearing structure and/or component of the grinding machine to be protected.

The flat component therefore serves in particular to thermally decouple the load-bearing structure and/or component of the grinding machine from the relevant fluid flow.

It may be provided that an air gap is formed between the flat component and the load-bearing structure and/or component to be protected, at least in sections. The air gap serves to avoid or reduce heat transfer between the flat component and the load-bearing structure and/or component to be protected. This is because the thermal conductivity of air is 0.024 W/(m*K) at 0° C.

Alternatively or additionally, it may be provided that an insulating material with low thermal conductivity, such as a plastic, in particular a cellular rubber, polystyrene or the like, may be arranged at least in sections between the flat component and the load-bearing structure and/or component to be protected.

The thermal conductivity of such an insulating material is in particular less than 1 W/(m*K) at 0° C., further in particular less than 0.5 W/(m*K) at 0° C., further in particular less than 0.1 W/(m*K) at 0° C.

In particular, it may be provided that an area formed between the flat component and the load-bearing structure and/or component to be protected is completely filled with an insulating material of low thermal conductivity.

It is possible that the flat component is covered with a material with low thermal conductivity.

A material thickness, in particular sheet thickness, of the flat component can be less than 5 mm, in particular less than 2 mm.

Alternatively or additionally, it may be provided that a length of the flat component can be more than 10 cm, in particular more than 20 cm.

Alternatively or additionally, it may be provided that a width of the flat component can be more than 10 cm, in particular more than 20 cm.

It may be provided that a material thickness of the above-mentioned insulating material is more than 0.5 cm, in particular more than 1 cm, in particular more than 2 cm, in particular more than 5 cm.

Alternatively or additionally, a length of the insulating material may be more than 10 cm, in particular more than 20 cm.

Alternatively or additionally, it may be provided that the width of the flat component is more than 10 cm, in particular more than 20 cm.

It may be provided that the insulating material is a plate-shaped component, i.e. has been made up, for example, from a plate-shaped base body, or that the insulating material is a mat-shaped component, i.e. has been made up, for example, from a mat-shaped base material that can be wound onto a roll, for example.

According to one design of the grinding machine, it may be provided that the load-bearing structure to be protected is a machine bed of the grinding machine, wherein the insulation device, as viewed in a vertical direction, is arranged between the device for discharging the cooling fluid and the machine bed, wherein the insulation device is arranged in particular within a machining space of the grinding machine which is closed during operation of the grinding machine and within which the machining of the workpiece to be toothed takes place by means of the gear machining tool.

During the grinding process, the cooling fluid is introduced into the area of the grinding contact between the tool or grinding tool and the workpiece to be toothed. The cooling fluid flows towards the machine bed or collects in the area of the machine bed and is usually discharged in the area of a drain, cleaned and reused in the cooling fluid circuit. The insulation device is arranged between the machine bed and the device for discharging the cooling fluid to prevent the cooling fluid from coming into direct contact with the machine bed.

It may be provided that the insulation device has an inclination and, in particular, is set up to guide cooling fluid to a cooling fluid drain or outlet. Horizontal surfaces or surfaces with a slight incline are potential areas in which cooling fluid can collect in large quantities. In these areas, where there is no or only very slow drainage, heat is transferred from the cooling fluid to the component wetted with cooling fluid over a particularly long period of time. This is to be avoided by the inclination described above, wherein the inclination is intended to promote faster drainage of the cooling fluid due to gravity.

It may be provided that the insulation device has a seal to an adjacent component or structure of the grinding machine in the area of one or more attachment points and/or at its edges in order to delimit an area of the grinding machine in which the fluid flow and/or the sparking occur, at least in sections from the area in which the load-bearing structure and/or component of the grinding machine to be protected is arranged.

The insulation device can be installed as a retrofit solution on an existing grinding machine. Alternatively, the insulation device can already be included in the design of a new grinding machine or integrated into the design.

It may be provided that the insulation device rests at least in sections on the load-bearing structure and/or component of the grinding machine to be protected. In the simplest case, for example, a load-bearing structure and/or component of the grinding machine to be protected is therefore covered with the insulation device in order to protect the structure and/or component in question from heat input. For example, the load-bearing structure and/or component to be protected can be covered with a foam rubber or other insulating material.

The examples above are largely related to the interior of the grinding machine, where the actual machining of the workpiece to be toothed takes place. However, as already mentioned at the beginning, environmental influences outside the interior of the grinding machine can also lead to temperature fluctuations that can influence the achievable machining accuracy in the single-digit micrometer range.

In accordance with a further design of the grinding machine, it can therefore be provided that the insulation device is arranged outside the machining space or interior of the grinding machine, which is closed during operation of the grinding machine, in order to protect the load-bearing structure and/or component of the grinding machine from ambient air, in particular draughts, from an environment of the grinding machine, wherein the insulation device can in particular be an enclosure which encloses the load-bearing structure and/or component of the grinding machine to be protected on the periphery, which enclosure extends or can extend in particular as far as a hall floor on which the grinding machine is set up, and can furthermore be sealed in particular against the hall floor.

The features “load-bearing structure of the grinding machine” and “load-bearing structure of the grinding machine to be protected” are used synonymously in this text and each refer to one and the same feature.

The features “component of the grinding machine” and “component of the grinding machine to be protected” are used synonymously in this text and each refer to one and the same feature.

### BRIEF DESCRIPTION OF THE DRAWINGS

The disclosure is explained in more detail below with reference to a drawing illustrating exemplary embodiments, wherein the drawings show schematically in each case:

FIG. 1 shows a grinding machine according to the disclosure;

FIG. 2 shows an insulation device of the grinding machine from FIG. 1;

FIG. 3 shows another insulation device;

FIG. 4 shows another insulation device;

FIG. 5 shows another insulation device; and

FIG. 6 shows the machine bed of the grinding machine from FIG. 1 with insulation devices.

### DETAILED DESCRIPTION OF THE DRAWINGS

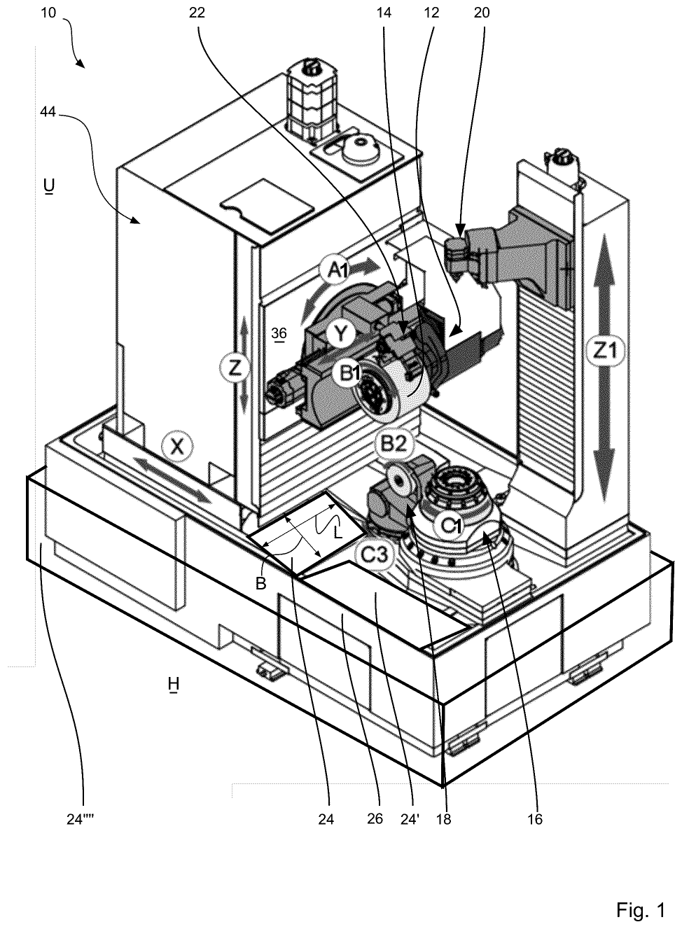

FIG. 1 shows a grinding machine 10 for gear grinding according to the disclosure.

The grinding machine 10 has a tool spindle 12 for holding and driving a gear machining tool 14. In the present case, the gear machining tool 14 is a grinding worm.

The grinding machine 10 has a workpiece spindle 16 for holding a workpiece to be toothed.

The grinding machine 10 has a plurality of controlled machine axes for executing relative movements for the chip-removing machining the workpiece to be toothed by means of the gear machining tool 14.

The machine axes are labeled with letters, wherein each of these letters is assigned an arrow that represents the respective degree of freedom of movement of the corresponding machine axes. In the present case, the grinding machine 10 has three linear axes X, Y, Z, which are provided for translational displacement of the tool spindle 12. A rotary drive of the gear machining tool 14 is labeled B1, wherein a pivot axis of the tool spindle 12 is labeled A1.

The axes B2 and C3 are assigned to the rotary drive and pivoting of a dresser 18.

The rotation axis C1 controls the rotation of the workpiece to be toothed during machining, wherein no workpiece to be toothed is shown in FIG. 1.

Furthermore, a linearly movable axis Z1 is provided, which is assigned to a sleeve 20 for clamping a toothed shaft or the like.

The grinding machine 10 has a device 22 for discharging a cooling fluid, which is set up to introduce cooling fluid into a region of the chip removal between the gear machining tool 14 and the workpiece to be toothed during the chip-removing machining operation.

In the present case, the grinding machine 10 has an insulation device 24 in order to protect a load-bearing structure 26 of the grinding machine 10 from a fluid flow and/or sparking. In the present case, the insulation device 24 serves in particular to protect the load-bearing structure 26 from the cooling fluid discharged by the device 22. The insulation device 24 can be fastened by screwing or gluing, in particular to a cladding, a holder or the like.

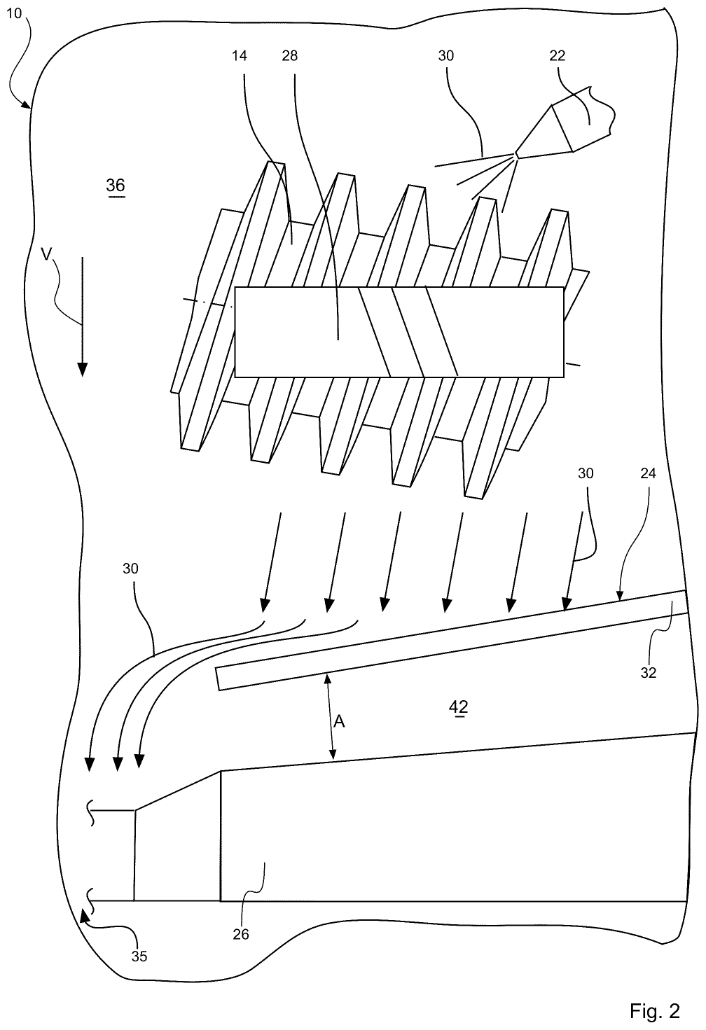

FIG. 2 shows schematically and by way of example a highly simplified and not to scale section of the machine tool 10, in which grinding machining of the workpiece 28 to be toothed shown in FIG. 2 by means of the grinding worm 14 is shown. During the grinding operation, cooling fluid 30 is introduced into the chip removal region between the workpiece 28 and the grinding worm 14 by means of the device 22.

The cooling fluid is discharged under pressure in the direction of the grinding worm 14 by means of a pump. After contact with the workpiece 28 and the grinding worm 14, the cooling fluid 30 travels downwards in vertical direction V, where it meets the insulation device 24. The insulation device 24 is inclined and directs the cooling fluid 30 towards a cooling fluid outlet 35.

The insulation device 24 prevents the cooling fluid 30 heated in the grinding contact from impinging on the load-bearing structure 26, which in the present case is a machine bed of the grinding machine 10. The insulation device 24 therefore ensures that the machine bed 26 is decoupled from the fluid flow of the cooling fluid 30, in particular thermally decoupled.

This can prevent heat from being introduced into the machine bed 26 by the cooling fluid 30, which could lead to heating of components supporting the machine axes or of components of the machine axes themselves and could impair the manufacturing accuracy of the grinding machine 10 due to thermal expansion.

In the present case, the insulation device 24 has a flat component in the form of a sheet 32, which is made of a metallic material. In the present case, the insulation device 24 has a distance A from the load-bearing structure 26 to be protected. An air gap is formed in the area of the distance A, so that an insulating air layer 42 is formed between the insulation device 24 and the machine bed 26.

As can be seen from the illustration according to FIG. 2, the insulation device 24 is arranged between the device 22 for applying the cooling fluid 30 and the load-bearing structure 26 to be protected, as viewed in the vertical direction V.

In addition, the insulation device 24 is arranged within a machining space 36 of the grinding machine 10 that is closed during operation of the grinding machine 10. The corresponding protective housing of the grinding machine 10 is not shown in the present case in order to simplify the illustration. However, it is known that grinding machines or machine tools or gear cutting machines in general have sliding or pivoting doors with a protective enclosure in order to achieve a safe separation of the machine operation in the interior 36 from an environment U.

FIG. 3 shows an example and schematic of a further design of an insulation device 24′, wherein the same reference signs are assigned to the same features to avoid repetition and only the differences to the example described above are discussed.

The insulation device 24′ also has a sheet 32. In addition, an insulating material 34 with low thermal conductivity is arranged between the sheet 32 and the machine bed 26 to be protected.

For both exemplary embodiments described above, it applies that a material thickness D or sheet thickness D of the sheet is less than 5 mm, in the present case less than 2 mm. It also applies that a length L of the sheet is more than 10 cm and that a width B of the sheet is more than 10 cm.

In the example shown in FIG. 3, the insulation device 24′ rests on the load-bearing structure 26 of the grinding machine 10 to be protected.

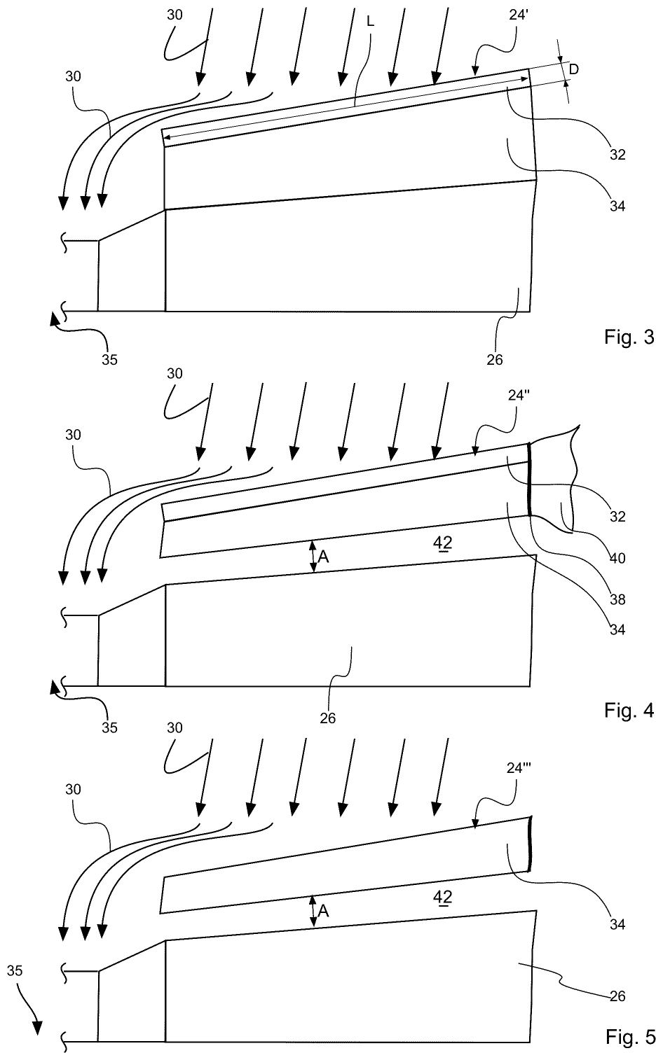

FIG. 4 shows an example and schematic of a further design of an insulation device 24″, wherein the same reference signs are assigned to the same features to avoid repetition and only the differences to the example described above are discussed.

The insulation device 24″ also has a sheet 32 and is also provided with an insulating material 34, in this example glued. In addition, the insulation device has a distance A, analogous to FIG. 2, so that an air gap is formed between the insulation device 24 and the load-bearing structure 26. In addition, the insulation device 24 is provided with a seal 38 to an adjacent component 40 of the grinding machine 10 in an edge-side area of an attachment. The seal 38 can also be an adhesive connection.

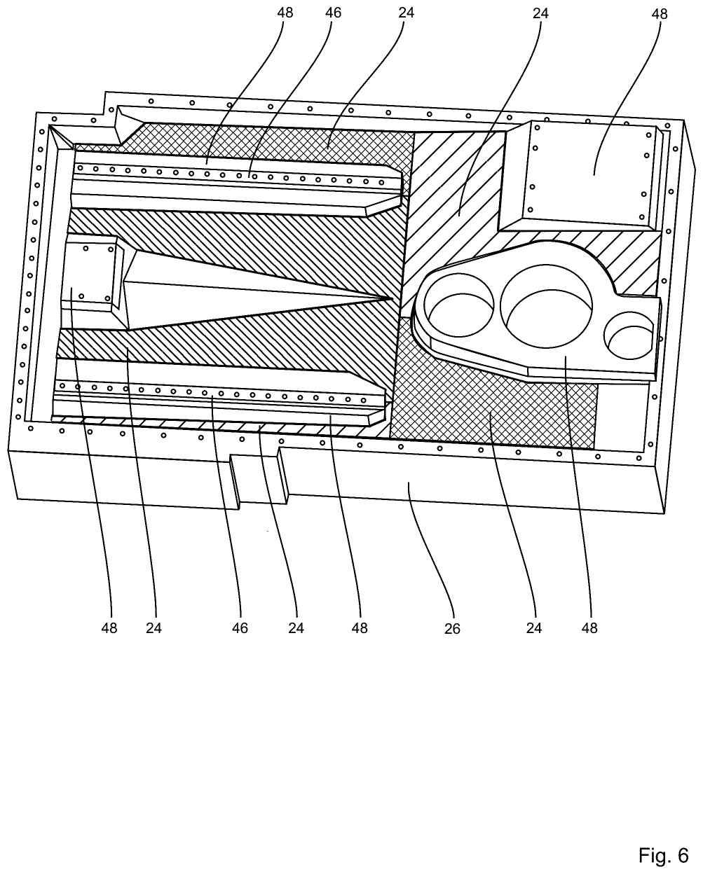

FIG. 5 shows a further exemplary and schematic design of an insulation device 24′″, which in the present case does not have a metal sheet, but only insulating material 34. In the present example, an air gap is again provided, but this can also be dispensed with according to alternative exemplary embodiments.

The grinding machine 10 may have two or more insulation devices 24, 24′, 24″, 24′″ associated with the interior 36 of the grinding machine 10 to protect the machine bed 26 and/or other components of the grinding machine 10 from being wetted with cooling fluid 30 and/or from sparking.

FIG. 1 shows a further exemplary and schematic design of an insulation device 24″″, which is arranged outside the machining space 36 of the grinding machine 10, which is closed during operation of the grinding machine 10, in order to protect the machine bed 26 of the grinding machine 10 from ambient air, in particular draughts, from an environment U of the grinding machine 10.

The insulation device 24″″ is an enclosure that surrounds the machine bed 26 of the grinding machine 10 on the periphery, extends as far as a hall floor H on which the grinding machine 10 is set up and is further sealed against the hall floor H.

FIG. 6 shows the machine bed 26 of the grinding machine 10, wherein the axis superstructures, i.e. the machine tower 44, which carries the tool spindle 12 and the device 22 for discharging a cooling fluid with the associated machine axes, as well as the corresponding axes and superstructures of the workpiece spindle 16 and the sleeve 20, are hidden in order to allow a free perspective view of the machine bed 26.

The machine bed 26 has guide rails 46 and mounting platforms 48 for holding the aforementioned axis assemblies.

Six insulation devices 24 are fitted between these mounting platforms 48. The insulation devices 24 are each shown with different hatching in order to visually distinguish them from the adjacent components or areas of the machine bed.

To simplify the illustration, all insulation devices are each given the reference sign 24. Each of the insulation devices 24 shown in FIG. 6 can be designed according to one of the principles shown above with reference to FIGS. 2-5. In other words, each of the insulation devices 24 shown in FIG. 6 may be designed in accordance with one of the insulation devices 24, 24′, 24″, 24′″. In other words, a machine bed can also be equipped with combinations of different types or configurations of insulation devices 24, 24′, 24″, 24′″.

As can be seen from FIG. 6, the insulation devices 24 cover in particular those areas of the machine bed 26 which are arranged between the mounting platforms 48 and which would be exposed without a corresponding covering by the insulation devices 24. The insulation devices 24 therefore prevent the areas of the machine bed 26 arranged between the mounting platforms 48 from being wetted with cooling fluid during machine operation and from heat input or temperature fluctuations due to the effects of the cooling fluid.

1. A grinding machine for gear grinding, the grinding machine comprising:
a tool spindle for holding a gear machining tool,
a workpiece spindle for holding a workpiece to be toothed,
a plurality of controlled machine axes for executing relative movements for chip-removing machining of the workpiece to be toothed by means of the gear machining tool,
a device for applying a cooling fluid, which is set up to introduce cooling fluid into a region of the chip removal between the gear machining tool and the workpiece to be toothed during the chip-removing machining operation,
wherein
at least one insulation device is provided in order to protect a load-bearing structure and/or a component of the grinding machine from a fluid flow and/or sparking.

2. The grinding machine according to claim 1,
wherein
the insulation device comprises a flat component, such as a sheet.

3. The grinding machine according to claim 2,
wherein
the flat component is at a distance from the load-bearing structure and/or component of the grinding machine to be protected
and/or
the insulation device is at a distance from the load-bearing structure and/or component of the grinding machine to be protected.

4. The grinding machine according to claim 3,
wherein
an air gap is formed at least in sections between the flat component and the load-bearing structure and/or component to be protected
and/or
an insulating material with low thermal conductivity, such as a plastic, is arranged at least in sections between the flat component and the load-bearing structure and/or component to be protected.

5. The grinding machine according to claim 2,
wherein
a material thickness of the flat component is less than 5 mm,
and/or
a length of the flat component is more than 10 cm,
and/or
a width of the flat component is more than 10 cm.

6. The grinding machine according to claim 1,
wherein
the load-bearing structure is a machine bed of the grinding machine, wherein the insulation device, as viewed in a vertical direction, is arranged at least in sections between the device for discharging the cooling fluid and the machine bed,
wherein the insulation device is arranged within a machining space of the grinding machine which is closed during operation of the grinding machine and within which the machining of the workpiece to be toothed takes place by means of the gear machining tool.

7. The grinding machine according to claim 1,
wherein
the insulation device has an inclination and is set up to guide cooling fluid to a cooling fluid outlet.

8. The grinding machine according to claim 1,
wherein
the insulation device has a seal to an adjacent component or structure of the grinding machine in the area of one attachment point or a plurality of attachment points and/or at its edges in order to delimit an area of the grinding machine in which the fluid flow and/or the sparking occur, at least in sections from the area in which the load-bearing structure and/or component of the grinding machine to be protected are arranged.

9. The grinding machine according to claim 1,
wherein
the insulation device rests at least in sections on the load-bearing structure and/or component of the grinding machine to be protected.

10. The grinding machine according to claim 1,
wherein
the insulation device is arranged outside the machining space of the grinding machine, which is closed during operation of the grinding machine, in order to protect the load-bearing structure and/or component of the grinding machine from ambient air, from an environment of the grinding machine,
wherein the insulation device is an enclosure which encloses the load-bearing structure and/or component of the grinding machine to be protected on the periphery, which enclosure extends, as far as a hall floor on which the grinding machine is set up, and is furthermore sealed against the hall floor.
